(19) United States
(12) Patent Application Publication
(10) Pub. No.: US 2005/0091139 A1
(43) Pub. Date: Apr. 28, 2005

(54) Transaction structures and methods concerning the forward sale of a commodity

(76) Inventors: Michael Kumar, New York, NY (US); Sadek Wahba, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/693,277

(22) Filed: Oct. 24, 2003

(51) Int. Cl. G06F 17/60

(52) U.S. Cl. 705/37

(57) ABSTRACT

Embodiments of the present invention are directed to methods related to a transaction structure for financing the sale of a commodity. According to one embodiment, the method includes establishing a forward contract between a company and a first business entity. The method may also include the first business entity offering debt securities to investors. Further, the method may include establishing a purchase agreement between the first business entity and a purchaser, wherein the purchase agreement obligates the purchaser to purchase the volumes of the commodity from the first business entity. Also, the method may include establishing a swap agreement between the purchaser and a party, wherein the swap agreement obligates the purchaser to pay the party an amount equal to the price at which the purchase sells the volumes of the commodity in the open market and obligates the party to pay the purchaser a fixed price.

### BACKGROUND OF THE INVENTION

The present invention is directed generally and in various embodiments to financial transactions and, more particularly, to structures and methods related to transaction structures concerning the forward sale of a commodity.

Commodity producers, such as oil and gas producing companies with developing fields, often wish to raise proceeds that are secured by its reserves. One way to do this is to enter into a forward sale agreement whereby the producing company agrees to sell specified quantities of the commodity at a fixed price, and offer debt securities secured by the future payments due from the forward sale agreement.

FIG. 1 is a diagram of a known transaction structure in which the commodity producing company 10 (such as an oil and gas producing company) enters into a pre-paid physical forward sale agreement with a special purpose vehicle (SPV) 12. An SPV is a legal entity formed solely in order to accomplish some specific task or tasks. The pre-paid physical forward sale agreement between the company 10 and the SPV 12 obligates the company 10 to deliver fixed volumes of the commodity to the SPV 12 according to a predetermined schedule in exchange for a one-time, upfront payment from the SPV 12. The SPV 12 pays the upfront payment with the proceeds from a debt security (e.g., notes or bonds) offering to investors 14. In addition, as shown in FIG. 1, the SPV 12 enters into a forward purchase agreement with a purchaser 16 of the commodity, which obligates the purchaser 16 to buy the scheduled fixed volume deliveries of the commodity from the SPV 12 at fixed prices. The purchaser 16 may then sell the commodity on the open market at market (floating) prices. In this scenario, the risk to the investor 14 includes the risk that the company 10 will not deliver to the SPV 12 the fixed volumes as specified in the pre-paid physical forward sale agreement and the risk that the purchaser 16 will not be able to pay for the commodity as required by the forward purchase agreement. Further, the purchaser 16 in this scenario faces the risk that the market (floating) price for the commodity may be less than the price specified in the forward purchase agreement.

### SUMMARY OF THE INVENTION

In one general respect, embodiments of the present invention are directed to methods related to transaction structures concerning the forward sale of a commodity. According to one embodiment, the method includes establishing a forward contract between a company and a first business entity. The first business entity may be a SPV owned by the company and the forward contract may obligate the company to deliver volumes of the commodity to the first business entity. In addition, the method may include the first business entity offering debt securities (e.g., notes or bonds) to investors. Further, the method may include establishing a forward purchase agreement between the first business entity and a purchaser, wherein the forward purchase agreement obligates the purchaser to purchase the volumes of the commodity from the first business entity according to a fixed schedule. Also, the method may include establishing a swap agreement between the purchaser and a party, wherein the swap agreement obligates the purchaser to pay the party an amount equal to the price at which the purchaser sells the volumes of the commodity in the open (floating) market and obligates the party to pay the purchaser a fixed price.

Various implementations of the method may include that the fixed price that the party is obligated to pay the purchaser pursuant to the swap agreement equals the price at which the purchaser is obligated to pay the first business entity (SPV) pursuant to the forward purchase agreement. In addition, the party with whom the purchaser enters the swap agreement may be the company or, in the alternative, a third party unrelated to the company.

Further, according to various embodiments, the method may include establishing a contingent supply agreement between the first business entity (SPV) and a second business entity. The contingent supply agreement may obligate the second business entity to supply volumes of the commodity to the first business entity if the company fails to deliver the necessary volumes of the commodity under the forward sale contract to meet the required deliveries to the purchaser under the forward purchase contract. The second business entity may be a parent of the company. In that case, the forward purchase agreement between the purchaser and the first business entity (SPV) may permit the purchaser to terminate the forward purchase agreement when the company defaults on the swap agreement, such as when the default of the company under the swap agreement exceeds a threshold amount specified in the contingent supply agreement. According to other embodiments, the second business entity may be unrelated to the company.

Embodiments of the present invention may reduce the risk exposure of the purchaser. Indeed, with certain embodiments described below, the risk to the purchaser may be reduced to the credit-worthiness of a single business entity in the transaction structure.

### DESCRIPTION OF THE FIGURES

Embodiments of the present invention will be described by way of example in conjunction with the following figures, wherein:

FIG. 1 is a diagram of a prior art transaction structure;

FIGS. 2-5 are diagrams of transaction structures according to various embodiments of the present invention; and

FIG. 6 is a diagram of a system according to various embodiments of the present invention.

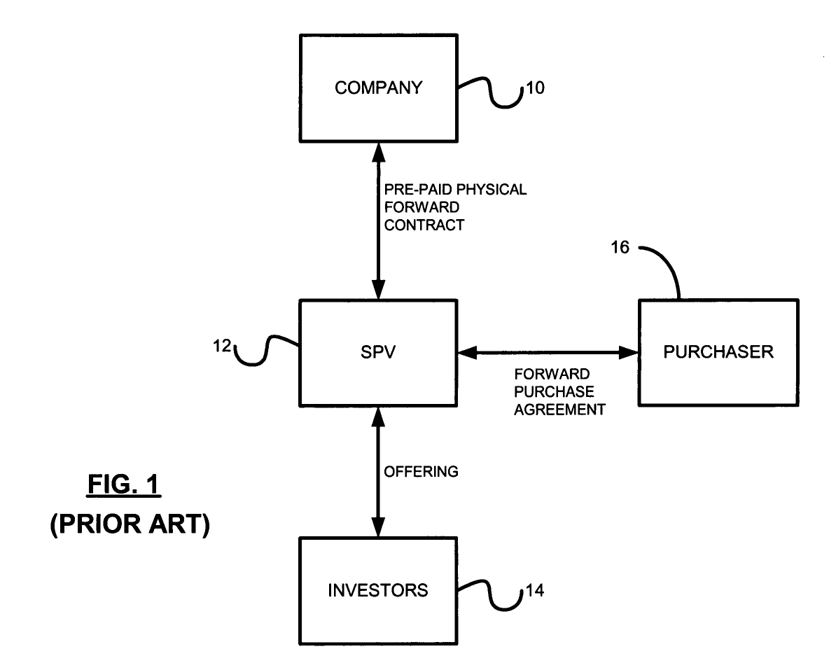

### DETAILED DESCRIPTION OF THE INVENTION

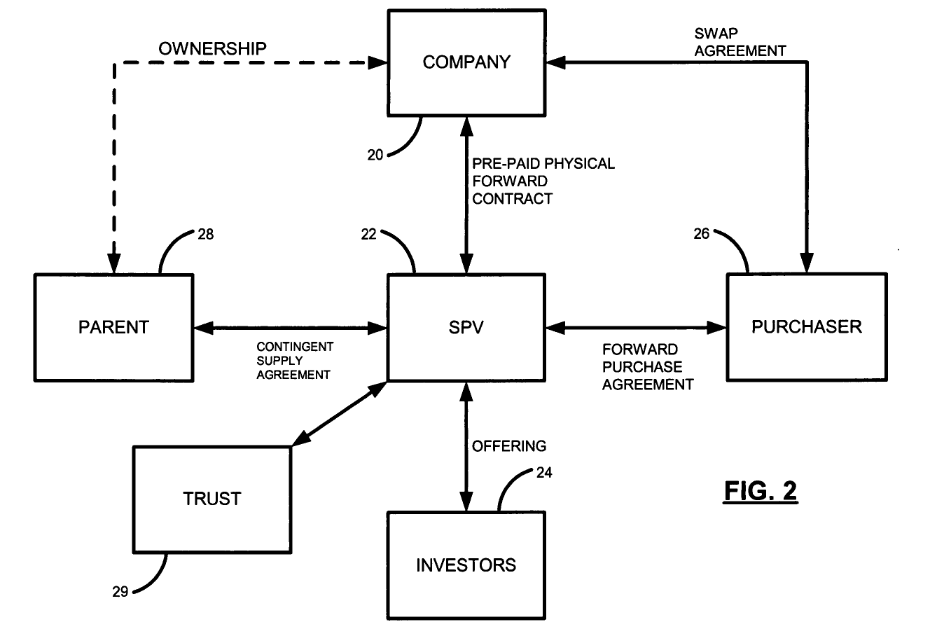

FIG. 2 is a diagram of a transaction structure according to various embodiments of the present invention. As shown in FIG. 2, a company 20 and an SPV 22 establish a pre-paid physical forward contract that requires the company 20 to deliver fixed volumes of a commodity to the SPV 22 according to a schedule for the term of the forward contract in exchange for an upfront, one-time payment from the SPV 22. The forward contract may be established between the two parties, for example, by the two parties negotiating and entering into the pre-paid physical forward contract, or by a third party (not shown) assigning and delegating its rights and/or obligations under an existing pre-paid physical forward contract to the SPV 22. The commodity may be any type of commodity such as, for example, crude oil, natural gas, ferrous or precious metals, soybeans, cottonseeds, etc.

Also as shown in FIG. 2, the SPV 22 may offer debt securities (e.g., notes or bonds) to investors 24. The SPV 22 may use the proceeds from the debt offering to make the upfront, one-time payment to the company 20 pursuant to the pre-paid physical forward contract. According to another embodiment, where, for example, an existing pre-paid physical forward contract is assigned and/or delegated to the SPV 22 by a third party, the SPV 22 may pay the third party for the assignment of the forward contract with proceeds from the debt security offering.

In addition, as shown in FIG. 2, the SPV 22 may enter into a purchase agreement, such as a forward purchase agreement, with a purchaser 26. The forward purchase agreement may obligate the purchaser 26 to purchase some or all of the fixed volumes of the commodity delivered by the company 20 to the SPV 22 pursuant to the pre-paid physical forward contract. According to another embodiment, the forward purchase agreement may be assigned and delegated to the SPV 22 by a third party (which may or may not be the third party that assigned an existing pre-paid physical forward contract to the SPV 22). The purchaser 26 may sell the quantities of the commodity purchased from the SPV 22 pursuant to the forward purchase agreement on the open market for market (or floating) prices.

Additionally, the SPV 22 may enter into a contingent supply agreement with a parent company 28 of the company 20. The contingent supply agreement may obligate the parent 28 to supply sufficient volumes of the commodity to the SPV 22 in the event that the company 20 is unable to perform, partially or completely, its obligations under the pre-paid physical forward contract. The contingent supply agreement may also, in the alternative, provide the parent 28 with the option of paying a financial settlement to the SPV 22 in the event that the company 20 is unable to perform. In such situations, the SPV 22 may use the financial settlement either (a) to procure replacement volumes to meet the delivery requirements to the purchaser 26 under the forward purchase agreement or (b) to pay any liquidated damages required to be paid under the terms of the forward purchase agreement to the purchaser 26.

In addition, the purchaser 26 may enter into a swap agreement with the company 20 through which the purchaser 26 may effectively fix the price at which it sells the commodity at a predetermined amount (the “swap price”). For example, according to one embodiment, under the swap agreement the purchaser 26 pays the company 20 an amount equal to the price at which the purchaser 26 sells the commodity in the open (floating) market (the “market price”) and in exchange the company 20 agrees to pay the purchaser 26 a fixed price. The fixed price specified in the swap agreement may be the same fixed price specified in the forward purchase agreement (i.e., the price at which the purchaser 26 buys the commodity from the SPV 22 pursuant to the forward purchase agreement). Thus, in effect, if the market (floating) price of the commodity is below the swap (fixed) price, the company 20 pays the purchaser 26 the difference between the market and swap prices. On the other hand, if the market price is above the swap price, the purchaser 26 may pay the company 20 the excess amount between the market and swap prices. In that way, the market risks to the purchaser 26 are reduced.

Further, according to various embodiments, the forward purchase agreement between the purchaser 26 and the SPV 22 may allow the purchaser 26 to terminate the forward purchase agreement if the contingent supply agreement between the parent 28 and the SPV 22 is terminated. In that connection, the contingent supply agreement may require the SPV 22 to terminate the contingent supply agreement when the company 20 (as a subsidiary of the parent 28) defaults on one of its contractual obligations, including the obligation of the company 20 under the swap agreement to pay the purchaser 26 the price at which the purchaser 26 sells the commodity in the open market. Thus, in effect, the contingent supply agreement may contain a so-called “cross-default” provision that stipulates that a default of the swap agreement by the company 20 results in default by the parent 28 of the contingent supply agreement, thereby requiring the SPV 22 to terminate the contingent supply agreement, hence allowing the purchaser 26 to terminate the forward purchase agreement. The contingent supply agreement may contain language, for example, that states that a default by the company 20 (or any of its subsidiaries) in an amount greater that a specified threshold amount causes a cross-default by the parent 28. Such arrangements further reduce the risk to the purchaser 26 to essentially the credit-worthiness of the parent 28.

The SPV 22 may be, for example, a subsidiary of the company 20 and may be incorporated in a country with favorable tax laws, such as the Cayman Islands, British Virgin Islands, etc. The business of the SPV 22 may be limited to (1) establishing and performing its obligations under the pre-paid physical forward contract, the forward purchase agreement, and the contingent supply agreement, (2) issuing the debt securities, (3) entering into the necessary transaction documents, as applicable, and (4) engaging in other activities in connection with the foregoing. In that connection, according to the indenture of the debt securities offered by the SPV 22, the SPV 22 may be subject to covenants that otherwise restrict its practices and abilities in order to safeguard the investors 24. For example, there may be restrictions on the SPV 22 with respect to incurring more debt.

In addition, the SPV 22 may be administered by a trust 29 that is independent from the purchaser 26, the company 20 and the parent 28. The trust 29 may maintain a collections account for the benefit of the SPV 22. All money that the purchaser 26 pays to the SPV 22 in accordance with the forward purchase agreement may be deposited in the collections account. The deposits may be done electronically, as described further below. Further, the trust 29 may pay the investors 24 the debt service (principal and interest payments) on the debt securities from the collections account. Any excess in the collections account may be used to pay administrative expenses of the SPV 22, such as the fees for the trust 29. Any further remaining excess may be transferred to the company 20. The excess cash in the collections account may also provide some measure of protection for the investors 24 should, for example, the company 20 or the purchaser 26 delay in some of their respective delivery or payment obligations.

Further, a reserve account may be established for the SPV 22. The reserve account may be funded, for example, with proceeds from the debt security offering with sufficient funds to cover the debt service on the debt securities for a certain time period, such as six months. Thus, the reserve account may further protect the investors 24 should either the company 20 or the purchaser 26 delay in some of their respective delivery or payment obligations.

According to other embodiments, the contingent supply agreement may contain no such cross-default provision, thus not permitting the purchaser 26 to terminate the forward purchase agreement with the SPV 22 if the company 20 fails to pay under the swap agreement. The purchaser 26 may prefer this variation if it is comfortable with the elevated risk associated therewith.

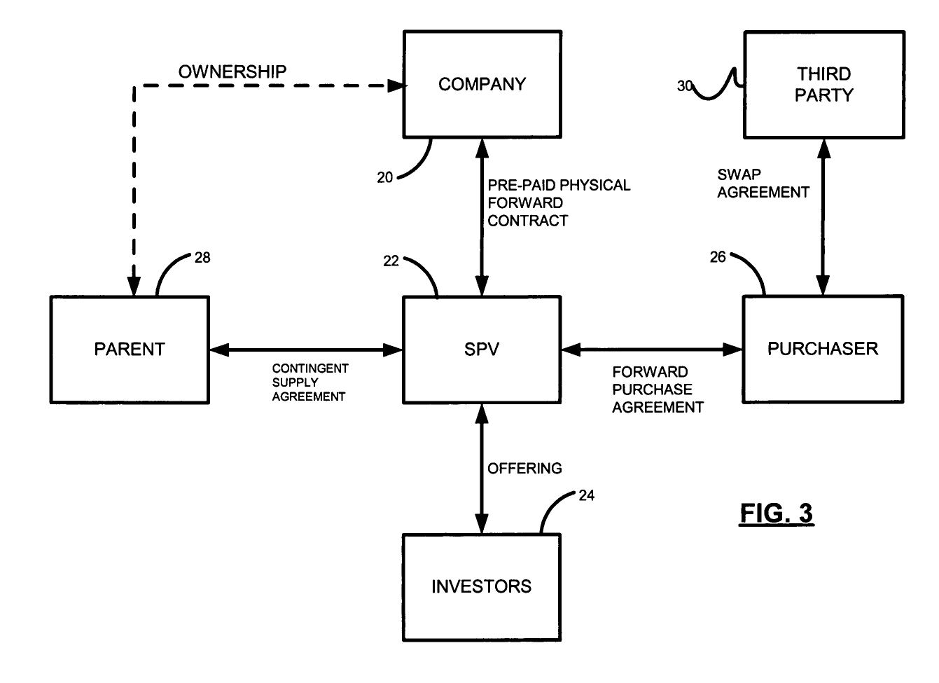

According to other embodiments, instead of entering into the swap agreement with the company 20, the purchaser 26 may enter into a swap agreement with a third party 30, as illustrated in FIG. 3. In this transaction structure, default by the third party 30 of its obligations under the swap agreement may not permit the purchaser 26 to terminate the forward purchase agreement. The purchaser 26 may prefer this variation where the third party 30 has a better credit rating than the company 20 and/or the parent 28.

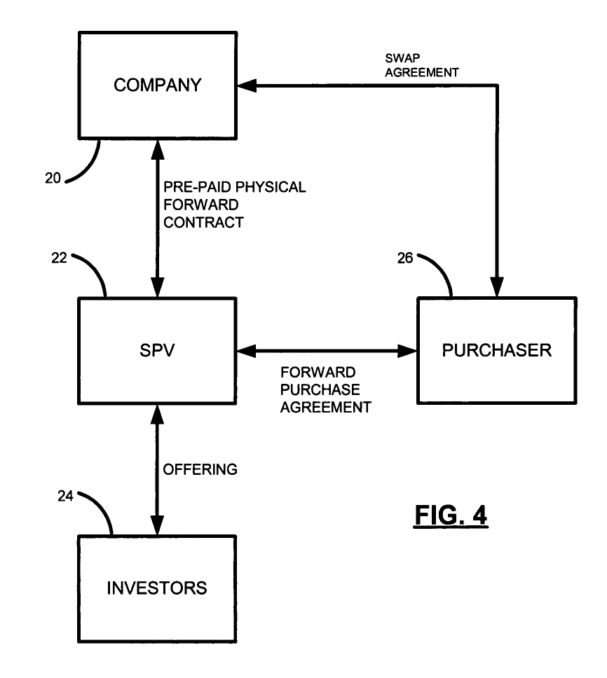

According to other embodiments, there may be no contingent supply agreement between the parent 28 and the SPV 22. For such embodiments, the purchaser 26 may enter into the swap agreement with the company 20, as illustrated in FIG. 4, but without a contingent supply agreement, the purchaser 26 may not be permitted to terminate the forward purchase agreement if the company 20 defaults under the swap agreement. According to alternative embodiments, the purchaser 26 may enter into the swap agreement with a third party (like in the structure of FIG. 3) without the existence of a contingent supply agreement between the parent 28 and the SPV 22.

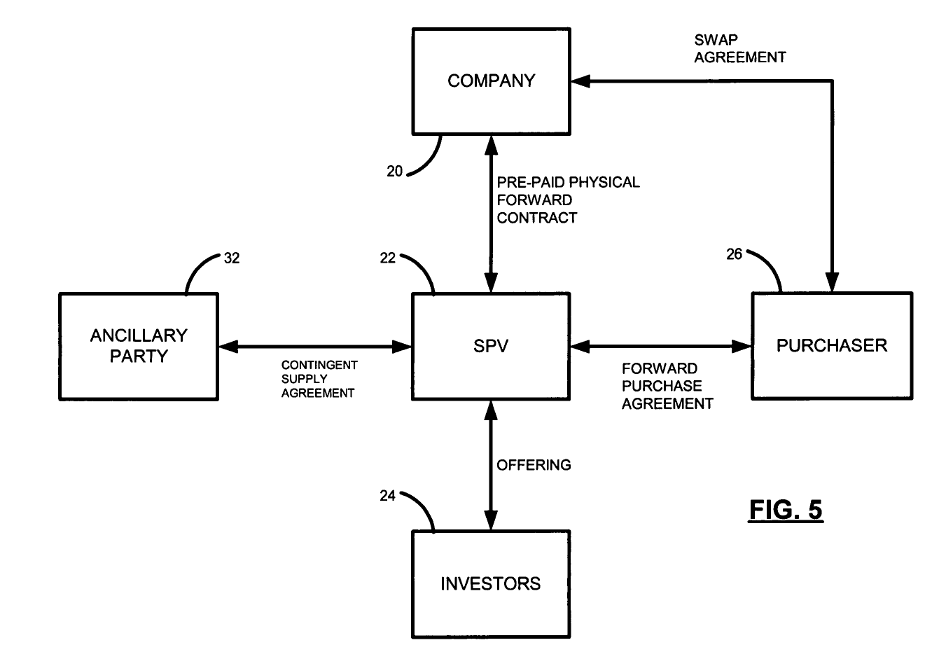

According to other embodiments, as illustrated in FIG. 5, as opposed to the parent 28 of the company 20 entering into the contingent supply agreement with the SPV 22, an ancillary party 32 may enter into the contingent supply agreement with the SPV. In such a structure, the ancillary party 32 may have no ownership relationship with the company 20. As such, the contingent supply agreement may contain no cross-default provisions whereby the purchaser 26 may terminate the forward purchase agreement if the company 20 defaults under the swap agreement. Alternatively, as mentioned before, the purchaser may enter into the swap agreement with a third party 30, as shown in FIG. 3.

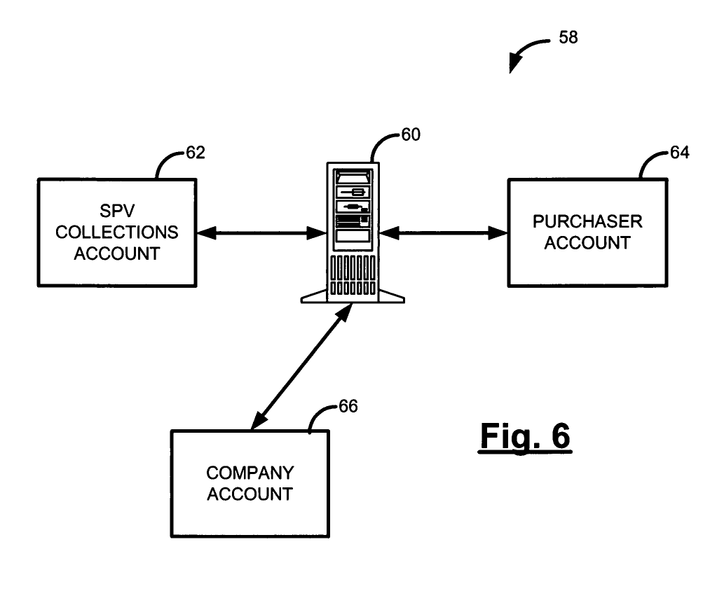

FIG. 6 is a diagram of a system 58 according to various embodiments of the present invention. As illustrated in FIG. 6, the system 58 may include a computer system 60. The computer system 60 may be used, for example, to electronically transfer funds between the collections account 62 of the SPV 56, an account 64 of the purchaser 26, and an account 66 of the company 20. Similar systems may be utilized for other types of transactions structures, such as those described in conjunction with FIGS. 3-5.

In FIG. 6, the computer device 60 is shown as a single unit for purposes of convenience, but it should be recognized that the computer device 60 may comprise a number of distributed or networked computing devices, inside and/or outside the same administrative domain. In order to electronically deposit funds in the various accounts, the computer device 60 may execute a series of instructions. The instructions may be software code to be executed by the computer device 60. The software code may be stored as a series of instructions or commands on a computer readable medium, such as a random access memory (RAM), a read only memory (ROM), a magnetic medium such as a hard-drive or a floppy disk, or an optical medium such as a CD-ROM, and may be written in any suitable computer language such as, for example, Java, C, or C++ using, for example, conventional or object-oriented techniques.

The above-described transaction structures have been described in the context of agreements requiring physical delivery. According to other embodiments, some of all of the agreements requiring physical delivery may instead be cash-settled transactions. In such embodiments, the system 58 of FIG. 6 may also be used to transact the cash-settled transactions.

While several embodiments of the invention have been described, it should be apparent, however, that various modifications, alterations and adaptations to those embodiments may occur to persons skilled in the art with the attainment of some or all of the advantages of the present invention. For example, the steps described above in connection with the various transaction structures may be performed in various orders. It is therefore intended to cover all such modifications, alterations and adaptations without departing from the scope and spirit of the present invention as defined by the appended claims.

1. In an arrangement whereby a company is obligated to deliver volumes of a commodity to a first business entity pursuant to a forward contract, and whereby the first business entity offers debt securities to investors, a method comprising:
a purchaser entering into a purchase agreement with the first business entity, wherein the purchase agreement obligates the purchaser to purchase the volumes of the commodity from the first business entity; and
the purchaser entering into a swap agreement with a party, wherein the swap agreement obligates the purchaser to pay the party an amount equal to the price at which the purchaser sells the volumes of the commodity in the open market and obligates the party to pay the purchaser a fixed price.

2. The method of claim 1, wherein the first business entity is a special purpose vehicle owned by the company.

3. The method of claim 1, wherein the fixed price that the party is obligated to pay the purchaser pursuant to the swap agreement equals the price at which the purchaser is obligated to pay the first business entity pursuant to the purchase agreement.

4. The method of claim 1, wherein the party with whom the purchaser enters the swap agreement is the company.

5. The method of claim 1, wherein the party with whom the purchaser enters the swap agreement is a third party unrelated to the company.

6. The method of claim 1, wherein the arrangement further obligates a second business entity to supply volumes of the commodity to the first business entity pursuant to a contingent supply agreement if the company fails to deliver the necessary volumes of the commodity required by the forward contract.

7. The method of claim 6, wherein the second business entity is a parent of the company.

8. The method of claim 7, wherein the purchase agreement between the purchaser and the first business entity permits the purchaser to terminate the purchase agreement when the company defaults on the swap agreement.

9. The method of claim 8, wherein the purchase agreement between the purchaser and the first business entity permits the purchaser to terminate the purchase agreement when the default of the company under the swap agreement exceeds a threshold amount specified in the contingent supply agreement.

10. The method of claim 6, wherein the second business entity is unrelated to the company.

11. In an arrangement whereby a company is obligated to deliver volumes of a commodity to a first business entity pursuant to a forward contract, and whereby the first business entity offers debt securities to investors, and whereby a parent of the company is obligated to supply volumes of the commodity to the first business entity pursuant to a contingent supply agreement if the company fails to deliver the necessary volumes of the commodity required by the forward contract, a method comprising:
a purchaser entering into a purchase agreement with the first business entity, wherein the purchase agreement obligates the purchaser to purchase the volumes of the commodity from the first business entity; and
the purchaser entering into a swap agreement with the company, wherein the swap agreement obligates the purchaser to pay the company an amount equal to the price at which the purchaser sells the volumes of the commodity in the open market and obligates the company to pay the purchaser a fixed price,
wherein the purchase agreement permits the purchaser to terminate the purchase agreement when the company defaults on the swap agreement.

12. The method of claim 11, wherein the purchase agreement between the purchaser and the first business entity permits the purchaser to terminate the purchase agreement when the default of the company under the swap agreement exceeds a threshold amount specified in the contingent supply agreement.

13. The method of claim 11, wherein the fixed price that the company is obligated to pay the purchaser pursuant to the swap agreement equals the price at which the purchaser is obligated to pay the first business entity pursuant to the purchase agreement.

14. The method of claim 11, wherein the first business entity is a special purpose vehicle owned by the company.

15. A method, comprising:
establishing a forward contract between a company and a first business entity, wherein the forward contract obligates the company to deliver volumes of a commodity to the first business entity;
the first business entity offering debt securities to investors;
establishing a purchase agreement between the first business entity and a purchaser, wherein the purchase agreement obligates the purchaser to purchase the volumes of the commodity from the first business entity; and
establishing a swap agreement between the purchaser and a party, wherein the swap agreement obligates the purchaser to pay the party an amount equal to the price at which the purchaser sells the volumes of the commodity in the open market and obligates the party to pay the purchaser a fixed price.

16. The method of claim 15, wherein the first business entity is a special purpose vehicle owned by the company.

17. The method of claim 15, wherein the fixed price that the party is obligated to pay the purchaser pursuant to the swap agreement equals the price at which the purchaser is obligated to pay the first business entity pursuant to the purchase agreement.

18. The method of claim 15, wherein the party with whom the purchaser enters the swap agreement is the company.

19. The method of claim 15, wherein the party with whom the purchaser enters the swap agreement is a third party unrelated to the company.

20. The method of claim 15, further comprising establishing a contingent supply agreement between the first business entity and a second business entity, wherein the contingent supply agreement obligates the second business entity to supply volumes of the commodity to the first business entity if the company fails to deliver the necessary volumes of the commodity required by the forward contract.

21. The method of claim 20, wherein the second business entity is a parent of the company.

22. The method of claim 21, wherein the purchase agreement between the purchaser and the first business entity permits the purchaser to terminate the purchase agreement when the company defaults on the swap agreement.

23. The method of claim 22, wherein the purchase agreement between the purchaser and the first business entity permits the purchaser to terminate the purchase agreement when the default of the company under the swap agreement exceeds a threshold amount specified in the contingent supply agreement.

24. The method of claim 20, wherein the second business entity is unrelated to the company.
